(19) United States
(12) Patent Application Publication
(10) Pub. No.: US 2023/0090920 A1
(43) Pub. Date: Mar. 23, 2023

(54) INFORMATION PROCESSING APPARATUS AND INFORMATION PROCESSING METHOD FOR ELECTRONIC RECEIPT SYSTEMS

(71) Applicant: TOSHIBA TEC KABUSHIKI KAISHA, Tokyo (JP)

(72) Inventors: Yumiko OKUMA, Koganei Tokyo (JP); Keiichi HASEGAWA, Koto Tokyo (JP); Yujiro UGAERI, Suginami Tokyo (JP); Nobuaki YAMAUCHI, Yokohama Kanagawa (JP); Yusuke OHTANI, Edogawa Tokyo (JP)

(21) Appl. No.: 17/850,286

(22) Filed: Jun. 27, 2022

(30) Foreign Application Priority Data
Sep. 17, 2021 (JP) 2021-152562

(51) Int. Cl. G06Q 20/38; G06Q 20/40

(52) U.S. Cl. CPC G06Q 20/389; G06Q 20/401

(57) ABSTRACT

According to one embodiment, an information processing apparatus for an electronic receipt system includes a communication interface and a control unit. The communication interface is configured to connect to a store server and a portable terminal. The control unit is configured to generate electronic receipt information based on commodity transaction information received from the store server via the communication interface, acquire position information corresponding to the commodity transaction information, and store the electronic receipt information and the position information in association with each other.

### CROSS-REFERENCE TO RELATED APPLICATION

This application is based upon and claims the benefit of priority from Japanese Patent Application No. 2021-152562, filed Sep. 17, 2021, the entire contents of which are incorporated herein by reference.

### FIELD

Embodiments described herein relate generally to an information processing apparatus and an information processing method for use with an electronic receipt system or the like.

### BACKGROUND

Conventionally, an electronic receipt system that issues an electronic receipt for a retail sales transaction is known.

However, in conventional electronic receipt systems, the ability to correlate additional information to an electronic receipt is not provided.

### BRIEF DESCRIPTION OF THE DRAWINGS

FIG. 1 is a diagram illustrating a configuration example of an electronic receipt system according to an embodiment.

FIG. 2 is a hardware block diagram of an electronic receipt server included in an electronic receipt system according to an embodiment.

FIG. 3 is a hardware block diagram of a point-of-sale (POS) terminal included in an electronic receipt system according to an embodiment.

FIG. 4 is a hardware block diagram of a portable terminal included in an electronic receipt system according to an embodiment.

FIG. 5 is a block diagram illustrating functional aspects of an electronic receipt server according to an embodiment.

FIG. 6 is a block diagram illustrating functional aspects of a POS terminal.

FIG. 7 is a block diagram illustrating functional aspects of a portable terminal.

FIG. 8 is a diagram illustrating an example of electronic receipt information associated with additional information.

FIG. 9 is a diagram illustrating another example of electronic receipt information associated with additional information.

FIG. 10 is a diagram illustrating an example in which an electronic receipt is correlated with a map and information is superimposed on the map.

FIG. 11 is a diagram illustrating an example in which an electronic receipt is correlated with a nearest train station and information is superimposed on a railway route map.

FIG. 12 is a diagram illustrating aspects of a process of correlating an electronic receipt with the nearest train station.

FIG. 13 is a flowchart of an additional information registration process performed by an electronic receipt system.

FIG. 14 is a flowchart of an additional information displaying process performed by an electronic receipt system.

### DETAILED DESCRIPTION

Embodiments provide an information processing apparatus and an information processing method for an electronic receipt system or service that is capable of correlating various additional information with an electronic receipt.

In general, according to one embodiment, an information processing apparatus (also referred to as an electronic receipt server in some contexts) for an electronic receipt system includes a communication interface and a control unit. The communication interface is configured to connect to a store server and a portable terminal. The control unit is configured to generate electronic receipt information based on commodity transaction information received from the store server via the communication interface, acquire position information corresponding to the commodity transaction information, and store the electronic receipt information and the position information in association with each other.

### Example Embodiment

An example embodiment of an electronic receipt system 10 will be described with reference to the drawings.

### System Configuration of Electronic Receipt System

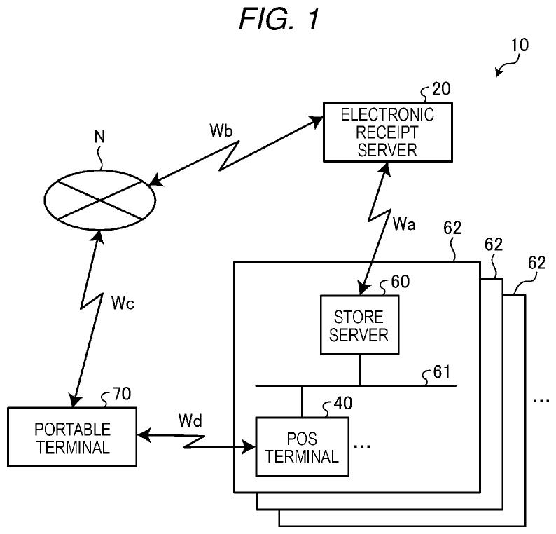

A system configuration of the electronic receipt system 10 will be described with reference to FIG. 1. FIG. 1 is a diagram illustrating an electronic receipt system according to the present embodiment.

The electronic receipt system 10 includes an electronic receipt server 20, a POS terminal 40, a store server 60 and a portable terminal 70 owned by a user. The POS terminal 40 and the store server 60 are installed in a store 62.

The electronic receipt server 20 and the store server 60 are connected by wireless connection Wa. The electronic receipt server 20 is connected to a network N by wireless connection Wb, and the portable terminal 70 is connected to the network N by wireless connection Wc. That is, the electronic receipt server 20 and the portable terminal 70 are wirelessly connected. The portable terminal 70 and the POS terminal 40 are connected by wireless connection Wd.

The electronic receipt server 20 acquires customer identification information identifying a customer and settlement information including commodity information about a commodity/item/product purchased by the customer in a retail sales transaction from the store server 60 of a store 62. The electronic receipt server 20 generates electronic receipt information indicating a result of the settlement. The electronic receipt information is based on the acquired settlement information and the customer identification information. The electronic receipt information may be generated by the POS terminal 40 or the store server 60. The electronic receipt information can include information such as a transaction number, store information indicating where the settlement was performed, commodity information (commodity name, unit price, quantity, amount) of items in the sales transaction, and the total amount due for the sales transaction. The electronic receipt server 20 stores the customer identification information and the electronic receipt information in correlation with each other. The electronic receipt server 20 also acquires additional information such as position information of the store location or the location of the portable terminal 70 at the time of settlement. Such additional information is stored correlated with the electronic receipt information. Furthermore, the electronic receipt server 20 stores the electronic receipt information and the additional information with each other. The electronic receipt server 20 transmits designated electronic receipt information to the portable terminal 70 in response to an instruction from the portable terminal 70. The electronic receipt server 20 is an example of an information processing apparatus of an embodiment.

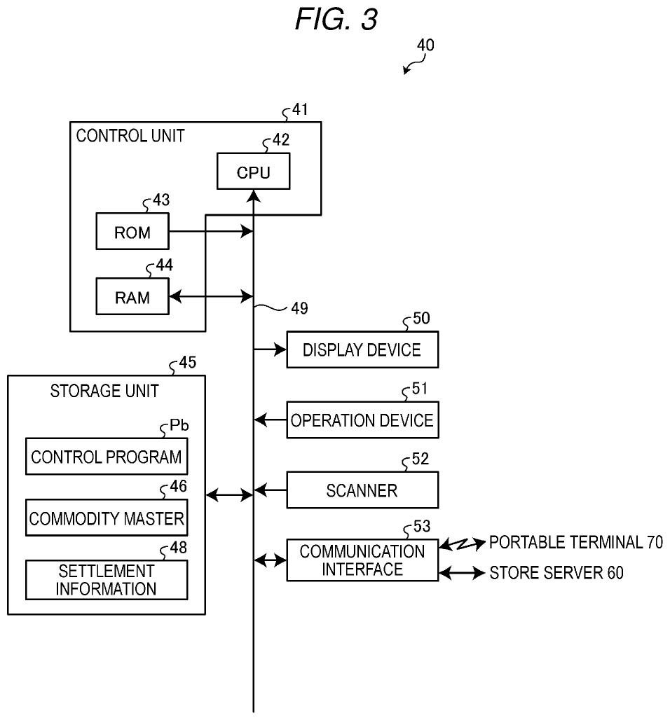

The POS terminal 40 performs a transaction accounting process (registering items) and a transaction settlement process (payment processing) for items purchased by the customer at the store 62. The POS terminal 40 acquires customer identification information for use of the electronic receipt system 10 (e.g., an electronic receipt service membership ID). For example, the POS terminal 40 acquires customer identification information from the portable terminal 70 via wireless communication. Alternatively, the POS terminal 40 may cause a scanner 52 (see FIG. 3) included in the POS terminal 40 to read coded information encoding the customer identification information. Such coded information may be displayed on the portable terminal 70. The store server 60 acquires settlement information from a plurality of POS terminals 40 at the store 62. The store server 60 transmits the acquired settlement information to the electronic receipt server 20. The POS terminal 40 and the store server 60 are connected to each other by an in-store network 61. The POS terminal 40 may itself generate electronic receipt information based on settlement information, and may transmit the generated electronic receipt information and customer identification information to the electronic receipt server 20.

The portable terminal 70 displays or otherwise outputs customer identification information for the use of the electronic receipt system 10 to the POS terminal 40. The portable terminal 70 acquires additional information to be associated with the electronic receipt information. The additional information is, for example, an image, text, a sound recording, or the like. The portable terminal 70 transmits this additional information along with position information for the additional information to the electronic receipt server 20. The portable terminal 70 designates the electronic receipt information to be associated with the transmitted additional information for the electronic receipt server 20.

The portable terminal 70 further issues an instruction to display the electronic receipt information stored in the electronic receipt server 20 and along with the corresponding (correlated) additional information. The portable terminal 70 receives electronic receipt information and the additional information that is instructed to be displayed in conjunction with the electronic receipt information from the electronic receipt server 20.

### Hardware Configuration of Electronic Receipt Server

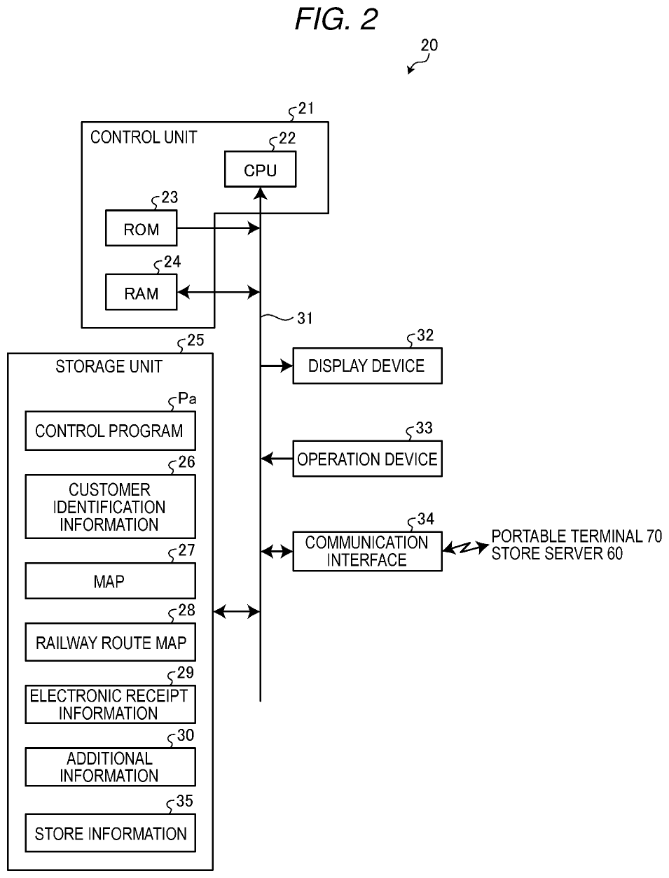

A hardware configuration of the electronic receipt server 20 will be described with reference to FIG. 2. FIG. 2 is a block diagram illustrating an example of the hardware configuration of the electronic receipt server 20 included in the electronic receipt system 10.

The electronic receipt server 20 includes a control unit 21 for controlling components of the electronic receipt server 20. The control unit 21 includes a central processing unit (CPU) 22, a read only memory (ROM) 23, and a random access memory (RAM) 24. The CPU 22 connects to the ROM 23 and the RAM 24 via a bus line 31 such as an address bus and a data bus. The CPU 22 loads various programs from the ROM 23 and/or a storage unit 25 into the RAM 24. The CPU 22 controls the electronic receipt server 20 by operating according to various programs loaded in the RAM 24. The control unit 21 in some examples may have a general computer configuration.

The control unit 21 connects to the storage unit 25, a display device 32, an operation device 33, and a communication interface 34 via the bus line 31.

The storage unit 25 is a storage device such as a hard disk drive (HDD) or solid-state drive (SSD). The storage unit 25 may be a non-volatile memory such as a flash memory in which stored information can be maintained even if a power source is turned off. The storage unit 25 stores, for example, a control program Pa, customer identification information 26, a map 27, a railway route map 28, electronic receipt information 29, additional information 30, and/or store information 35.

The control program Pa is a computer program for controlling the overall operation of the electronic receipt server 20.

The customer identification information 26 includes the membership numbers of the members authorized (registered) to use the electronic receipt system 10. The electronic receipt server 20 also stores various attribute information such as an e-mail address for the member in correlation with a membership number included in the customer identification information 26.

The map 27 is map data including geographical information such as roads and buildings.

The railway route map 28 is a route map including route information of a specific railway line. A position (latitude, longitude, and the like) of a station illustrated in the railway route map 28 is correlated with the map 27. In addition to the railway route map 28, a traffic route map such as a bus route map or a road map may be included.

The electronic receipt information 29 is generated based on a result of the settlement process performed by a POS terminal 40. The electronic receipt information 29 includes customer identification information of the customer who performed the settlement process, commodity information for the sold item(s), the contents of settlement process (e.g., payment method, amount tendered, change returned, etc.), and position information of the store 62 where the settlement was performed.

The additional information 30 can be a photograph, a memo (text notation), and/or a voice message (sound recording). The additional information 30 is associated with particular electronic receipt information 29 of the member of the electronic receipt system 10. Such additional information may be provided or designated by the member. The number of different pieces of additional information 30 associated with the electronic receipt information 29 is not particularly limited. The electronic receipt information 29 may be associated with more than one type of additional information 30 (e.g., both a photograph and voice message). The electronic receipt server 20 stores the additional information 30 in correlation with the relevant customer identification information. The portable terminal 70 of the member may also or instead store the additional information 30. In such a case, the electronic receipt server 20 stores identification information such as an ID number for specifying a particular piece of additional information 30 stored in the portable terminal 70.

The store information 35 includes position information for a plurality of stores 62. The store information 35 can include a street address, latitude and longitude, a store name, a telephone number, or the like for each store 62.

The display device 32 displays a screen generated by an instruction of the control unit 21. The display device 32 is a liquid crystal display (LCD) or an organic electro-luminescence (EL) device.

The operation device 33 provides information through an input operation by an operator and transmits the information to the control unit 21. The operation device 33 is a device such as a keyboard or a touch panel.

The communication interface 34 is for communicating with the portable terminal 70 and the store server 60 via a wireless communication method such as a wireless LAN.

### Hardware Configuration of POS Terminal

A hardware configuration of the POS terminal 40 will be described with reference to FIG. 3. FIG. 3 is a hardware block diagram of the POS terminal 40 included in the electronic receipt system 10.

The POS terminal 40 includes a control unit 41 for controlling each component. The control unit 41 includes a CPU 42, a ROM 43, and a RAM 44. The CPU 42 connects to the ROM 43 and the RAM 44 via a bus line 49 such as an address bus and a data bus. The CPU 42 loads various programs from the ROM 43 and/or a storage unit 45 into the RAM 44. The CPU 42 controls the POS terminal 40 by operating according to various programs loaded in the RAM 44. That is, the control unit 41 can have a general computer configuration in some examples.

The control unit 41 connects to the storage unit 45, a display device 50, an operation device 51, a scanner 52, and a communication interface 53 via the bus line 49.

The storage unit 45 is a storage device such as an HDD or an SSD. The storage unit 45 may be a non-volatile memory such as a flash memory in which stored information is maintained even if a power source is turned off. The storage unit 45 stores a control program Pb, a commodity master 46, and settlement information 48.

The control program Pb is a program that controls the operations of the POS terminal 40.

The commodity master 46 is a master file that stores commodity information of the items sold at a store. In some examples, the commodity master 46 may be stored in the store server 60, and the POS terminal 40 may inquire of the store server 60 when registering an item or commodity.

The settlement information 48 indicates the result of settlement process performed at the POS terminal 40. The settlement information 48 is not yet converted into an electronic receipt, but rather can be a different data format at this time.

The display device 50 displays a screen generated by an instruction of the control unit 41. The display device 50 is a device such as an LCD or an organic EL device.

The operation device 51 provides information through an input operation by an operator and transmits the information to the control unit 41. The operation device 51 is a device such as a keyboard or a touch panel.

The scanner 52 reads code information (for example, a bar code) attached or printed on the commodity when the customer registers the commodity for purchase. The scanner 52 reads bar code information from products as well encoded information including customer identification information 76 that can be displayed on a portable terminal 70 of a customer. The scanner 52 can be a fixed scanner or a hand-held (“handy”) scanner.

The communication interface 53 is for communicating with the portable terminal 70 via wireless communication such as a wireless LAN. The communication interface 53 is also for communicating with the store server 60 via a wired communication such as a wired LAN.

The store server 60 functions as a repeater, for example, when the electronic receipt server 20 and the POS terminal 40 communicate with each other. Since the store server 60 only needs to have a general-purpose computer configuration, the description of the hardware configuration thereof is omitted.

### Hardware Configuration of Portable Terminal.

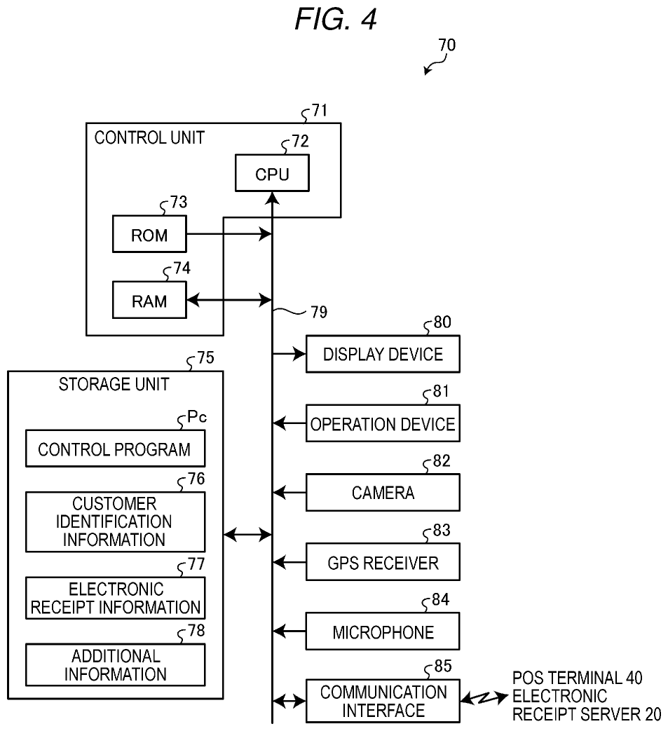

The hardware configuration of the portable terminal 70 will be described with reference to FIG. 4. FIG. 4 is a block diagram illustrating an example of the hardware configuration of a portable terminal 70 included in the electronic receipt system 10.

The portable terminal 70 includes a control unit 71 for controlling each component. The control unit 71 includes a CPU 72, a ROM 73, and a RAM 74. The CPU 72 connects to the ROM 73 and the RAM 74 via a bus line 79 such as an address bus and a data bus. The CPU 72 loads various programs from the ROM 73 and the storage unit 75 into the RAM 74. The CPU 72 controls the portable terminal 70 by operating according to various programs loaded in the RAM 74.

The control unit 71 connects to the storage unit 75, a display device 80, an operation device 81, a camera 82, a GPS receiver 83, and a microphone 84 via the bus line 79.

The storage unit 75 is a storage device such as an HDD or an SSD. The storage unit 75 may be a non-volatile memory such as a flash memory. The storage unit 75 stores a control program Pc, customer identification information 76, electronic receipt information 77, and additional information 78.

The control program Pc is a computer program that controls the operations of the portable terminal 70.

The customer identification information 76 is a membership number of a user of the portable terminal 70. The portable terminal 70 stores attribute information such as an e-mail address in correlation with the customer identification information 76.

The electronic receipt information 77 is electronic receipt information indicating the result of the settlement process when the user of the portable terminal 70 purchases a commodity.

The additional information 78 is information such as a photograph, a memo, or a voice message correlated with the electronic receipt information 77 by the user of the portable terminal 70. A collection of additional information 78 may be stored in the electronic receipt server 20, or such a collection may be stored in the portable terminal 70. If the additional information 78 is stored in the portable terminal 70, identification information specifying particular additional information 78 can be stored in the electronic receipt server 20. That is, the additional information 30 stored in the electronic receipt server 20 and the additional information 78 stored in the portable terminal 70 can refer or relate to each other. In the subsequent description, the additional information 30 and the additional information 78 are not distinguished from each other, and are simply referred to as additional information 30.

The display device 80 displays a screen generated by an instruction of the control unit 71. The display device 80 is configured with a device such as a LCD or an organic electro-luminescence (EL).

The operation device 81 acquires information through an input operation from an operator (user) and transmits such information to the control unit 71. The operation device 81 receives text inputs when acquiring text information as the additional information 30. The operation device 81 can be a device such as a keyboard or a touch panel.

The camera 82 captures an image of a commodity or the like for acquiring image information as the additional information 30.

The GPS receiver 83 acquires position information (latitude/longitude, route, and the like) of the portable terminal 70 when the additional information 30 is acquired.

The microphone 84 provides sound for acquiring voice memo information (or a sound recording more generally) as the additional information 30.

A communication interface 85 is for communicating with the POS terminal 40 and the electronic receipt server 20 via wireless communication such as a wireless LAN.

### Functional Configuration of Electronic Receipt Server

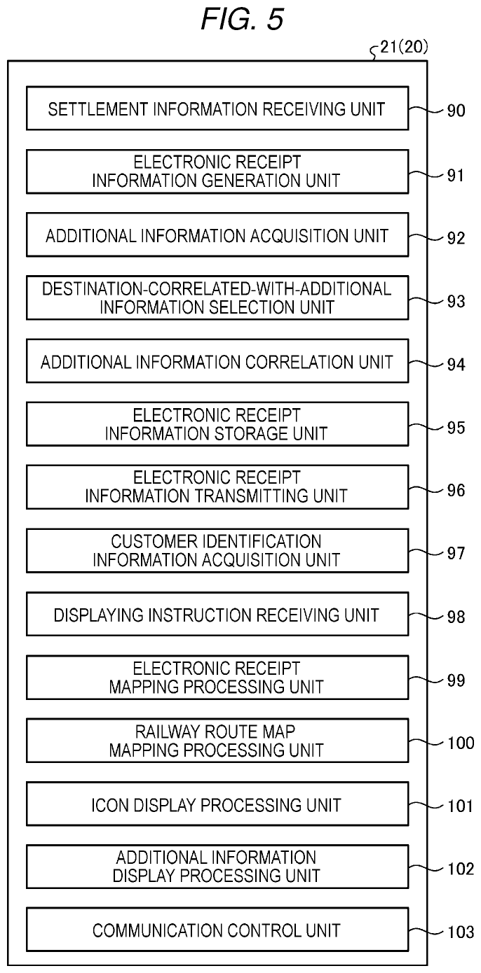

Next, functional aspects of the electronic receipt server 20 will be described with reference to FIG. 5. FIG. 5 is a block diagram illustrating an example of the functional aspects of the electronic receipt server 20 included in the electronic receipt system 10.

The control unit 21 of the electronic receipt server 20 loads the control program Pa into the RAM 24 and executes the control program to realize the described functions of a settlement information receiving unit 90, an electronic receipt information generation unit 91, an additional information acquisition unit 92, an additional information correlation destination selection unit 93, an additional information correlation unit 94, an electronic receipt information storage unit 95, an electronic receipt information transmitting unit 96, a customer identification information acquisition unit 97, a displaying instruction receiving unit 98, an electronic receipt mapping processing unit 99, a railway route map mapping processing unit 100, an icon display processing unit 101, an additional information display processing unit 102, and a communication control unit 103, which are illustrated in FIG. 5.

The settlement information receiving unit 90 receives settlement information from the store server 60.

The electronic receipt information generation unit 91 generates the electronic receipt information 29 including commodity information of the sold commodity based on the settlement information.

The additional information acquisition unit 92 acquires the additional information 30 from the portable terminal 70 of the user who performed the settlement related to the electronic receipt information 29. As described above, the additional information 30 may be identification information for pointing to a particular photograph, memo, and sound recording or the like stored in the portable terminal 70.

The additional information correlation destination selection unit 93 permits the user of the portable terminal 70 to select whether to correlate additional information 30 with the electronic receipt information 29 overall or to correlate additional information 30 with individual purchased items included in the electronic receipt information 29. The additional information correlation destination selection unit 93 is an example of a selection unit of an exemplary embodiment.

The additional information correlation unit 94 associates the electronic receipt information 29 with the additional information 30.

The electronic receipt information storage unit 95 stores the customer identification information 76, the electronic receipt information 29, and the additional information 30 in correlation with each other. The electronic receipt information storage unit 95 also stores the electronic receipt information 29 for which no additional information 30 is associated.

The electronic receipt information transmitting unit 96 transmits the electronic receipt information 29 to the portable terminal 70 of the user who performed the settlement related to the electronic receipt information 29.

The customer identification information acquisition unit 97 acquires the customer identification information 76 from the portable terminal 70.

The displaying instruction receiving unit 98 receives an instruction to display electronic receipt information 29 from the portable terminal 70.

The electronic receipt mapping processing unit 99 correlates the electronic receipt information 29 including the customer identification information 76 with the position of the store 62 on the map 27 where the settlement related to the electronic receipt information 29 was performed.

The railway route map mapping processing unit 100 correlates the electronic receipt information 29 correlated with the map 27 with a station nearest the store 62 on the railway route map 28. In some examples, the railway route map mapping processing unit 100 may directly correlate the store 62 with the nearest station in the railway route map 28 rather than by reference to map 27 information.

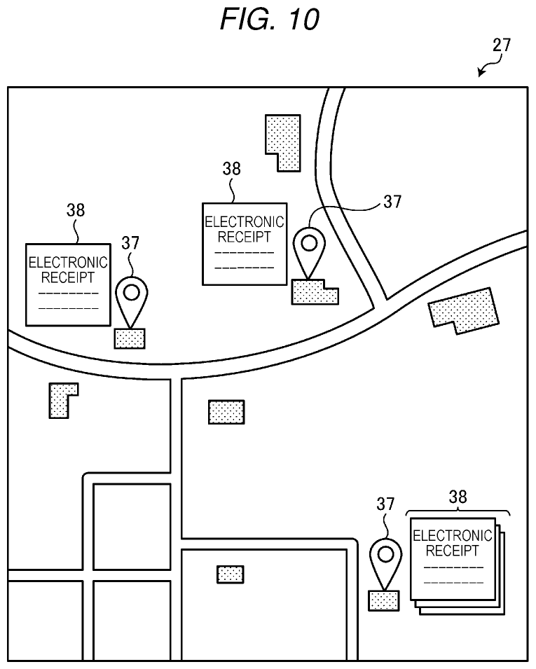

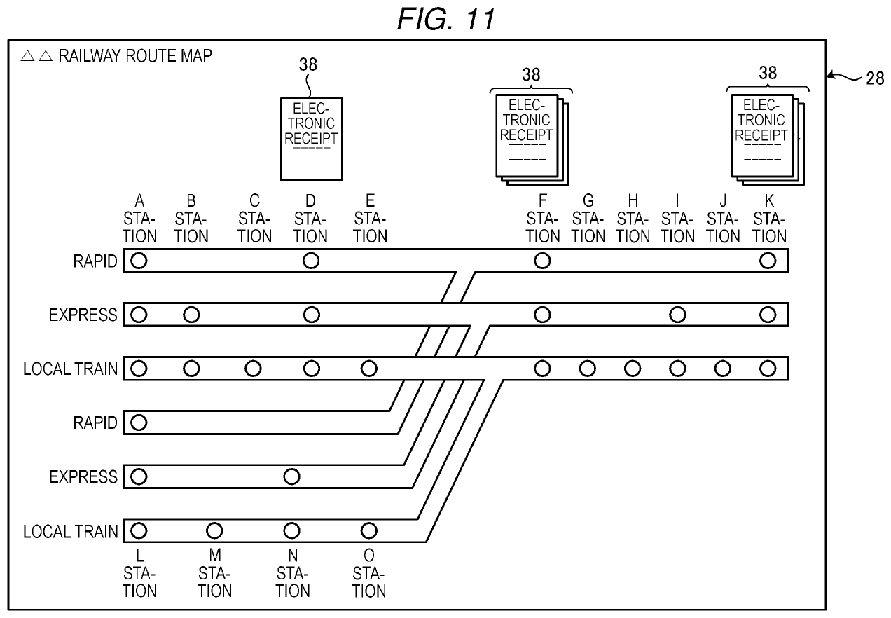

The icon display processing unit 101 superimposes an identification icon 37 indicating that electronic receipt information 29 correlated with a position (a store 62 location) on the map 27, which is displayed on the display device 80 of the portable terminal 70. The icon display processing unit 101 also superimposes an electronic receipt icon 38 on the map 27 (see FIG. 10). The electronic receipt icon 38 may also be displayed on the railway route map 28 at the position corresponding to the nearest station to the store 62 (see FIG. 11). The icon display processing unit 101 is an example of an icon display unit of an exemplary embodiment.

The additional information display processing unit 102 causes the display device 80 to display the additional information 30 that is associated with the electronic receipt information 29 corresponding to the electronic receipt icon 38 when operation information to designate the electronic receipt icon 38 is received from the user. The additional information display processing unit 102 is an example of an additional information display unit of an exemplary embodiment.

The communication control unit 103 controls communication between the electronic receipt server 20, the store server 60, and the portable terminal 70.

### Functional Configuration of POS Terminal

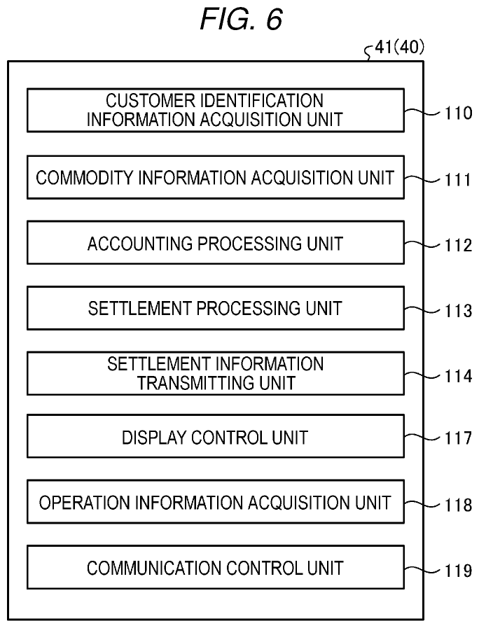

Next, the functional aspects of the POS terminal 40 will be described with reference to FIG. 6. FIG. 6 is a block diagram illustrating an example of the functional configuration of a POS terminal 40 included in the electronic receipt system 10.

The control unit 41 of the POS terminal 40 loads the control program Pb into the RAM 44 and executes the control program to realize the described functions of a customer identification information acquisition unit 110, a commodity information acquisition unit 111, an accounting processing unit 112, a settlement processing unit 113, a settlement information transmitting unit 114, a display control unit 117, an operation information acquisition unit 118, and a communication control unit 119, which are illustrated in FIG. 6.

The customer identification information acquisition unit 110 receives the customer identification information 76 for the electronic receipt system 10 from the portable terminal 70. Specifically, the POS terminal 40 reads coded information including or otherwise providing the customer identification information 76 with the scanner 52. The coded information can be displayed on the display device 80 of the portable terminal 70. In some examples, the customer identification information 76 may be transmitted from the portable terminal 70 to the POS terminal 40 by wireless communication.

The commodity information acquisition unit 111 acquires information that uniquely specifies a commodity being purchased by a customer. The information that uniquely specifies the commodity is, for example, code information attached or printed on the commodity, code information printed on a slip, or the like.

The accounting processing unit 112 calculates a total payment amount by adding individual values obtained by multiplying a commodity unit price by the number of purchased commodities. The relevant commodity information is acquired by the commodity information acquisition unit 111.

The settlement processing unit 113 performs a settlement process based on a payment method designated by the customer based on the total payment amount calculated by the accounting processing unit 112.

The settlement information transmitting unit 114 transmits the settlement information generated by the settlement processing unit 113 to the electronic receipt server 20.

The display control unit 117 generates a display screen to be displayed on the display device 50 of the POS terminal 40. The display control unit 117 outputs the generated display screen to the display device 50.

The operation information acquisition unit 118 acquires operation information performed by the operation device 51 of the POS terminal 40 and delivers the operation information to the control unit 41. The control unit 41 controls the POS terminal 40 according to the acquired operation information.

The communication control unit 119 controls communication between the POS terminal 40 and the store server 60 and the portable terminal 70.

### Functional Configuration of Portable Terminal

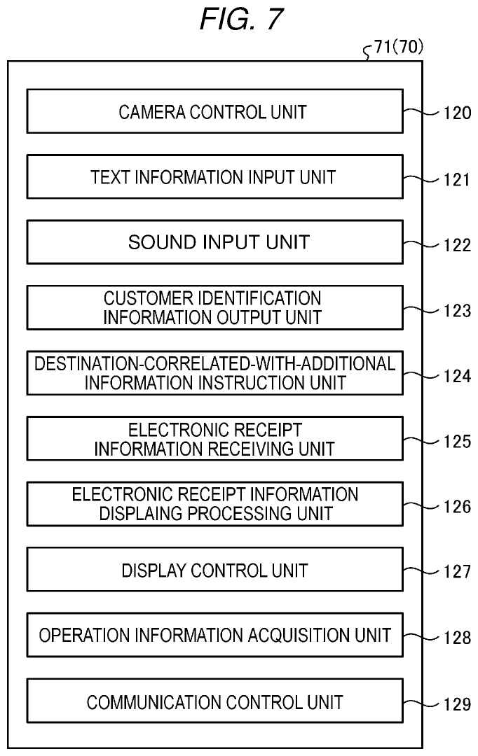

Next, a functional configuration of the portable terminal 70 will be described with reference to FIG. 7. FIG. 7 is a functional block diagram illustrating an example of the functional configuration of the portable terminal included in the electronic receipt system.

The control unit 71 of the portable terminal 70 loads the control program Pc in the RAM 74 and executes the control program to realize the described functions of a camera control unit 120, a text information input unit 121, a sound input unit 122, a customer identification information output unit 123, an additional information correlation instruction unit 124, an electronic receipt information receiving unit 125, an electronic receipt information displaying processing unit 126, a display control unit 127, an operation information acquisition unit 128, and a communication control unit 129, which are illustrated in FIG. 7 as functional units.

The camera control unit 120 controls image capturing of the camera 82 included in the portable terminal 70.

The text information input unit 121 provides text information corresponding to user operations on the operation device 81 or the like.

The sound input unit 122 provides voice or sound information from the microphone 84.

The customer identification information output unit 123 outputs the customer identification information 76 to the POS terminal 40. The customer identification information output unit 123 may display coded information, such as barcode, for providing a membership number on the display device 80 of the portable terminal 70, or may transmit the coded information to the POS terminal 40 via wireless communication. When the user of the portable terminal 70 accesses the electronic receipt server 20 for displaying electronic receipt information or the like, the customer identification information output unit 123 transmits the customer identification information 76 to the electronic receipt server 20 for authentication purposes.

The additional information correlation instruction unit 124 instructs whether to associate additional information 30 with the electronic receipt information 29 itself or with the individual commodities included in the electronic receipt information 29 based on the instruction/preference of the user of the portable terminal 70.

The electronic receipt information receiving unit 125 receives the electronic receipt information 29 as designated by the user of the portable terminal 70 from the electronic receipt server 20.

The electronic receipt information displaying processing unit 126 causes the additional information 30 associated with the electronic receipt information 29 to be displayed on the portable terminal 70 based on user instruction.

The display control unit 127 generates a display screen to be displayed on the display device 80 of the portable terminal 70. The display control unit 127 outputs the generated display screen to the display device 80.

The operation information acquisition unit 128 acquires the operation information performed by a user on the operation device 81 of the portable terminal 70 and delivers the operation information to the control unit 71. The control unit 71 controls the portable terminal 70 according to the acquired operation information.

The communication control unit 129 controls communication between the portable terminal 70 and the electronic receipt server 20 and the POS terminal 40.

### Contents of Electronic Receipt Information

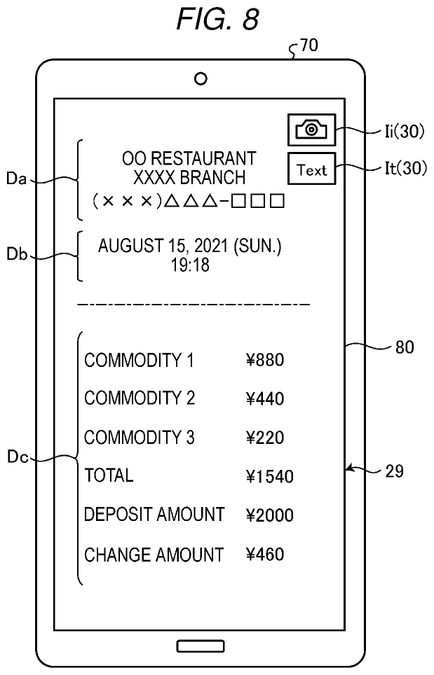

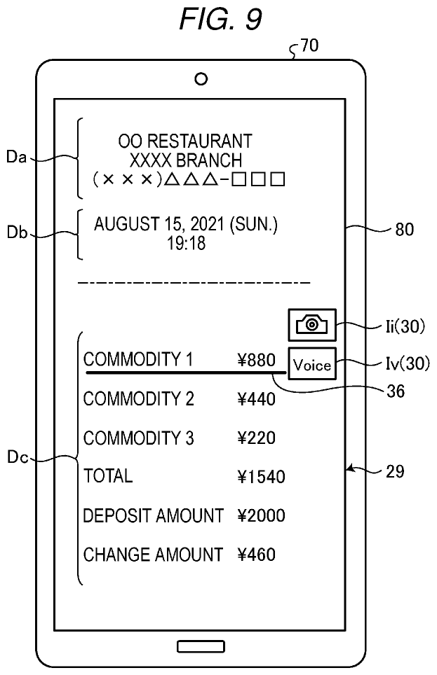

The contents of the electronic receipt information 29 generated by the electronic receipt server 20 will be described with reference to FIGS. 8 and 9. FIG. 8 is a first diagram illustrating an example of electronic receipt information 29 to which additional information 30 can be correlated. FIG. 9 is a second diagram illustrating an example of electronic receipt information 29 to which additional information 30 has been associated.

As illustrated in FIG. 8, the electronic receipt information 29 includes store information Da, purchase date information db, and commodity information Dc.

The store information Da includes a store name, a telephone number, and the like. Although position information of the store 62 does not appear in the electronic receipt information 29 as displayed, the electronic receipt information 29 is in fact associated with the position information of the store 62 where the settlement was performed. Therefore, as will be described further, the user of the portable terminal 70 can search for the electronic receipt information 29 on the map 27 (see FIG. 10).

The purchase date information db includes the date and time the settlement was performed.

The commodity information Dc includes a purchased commodity name, a unit price, and a total amount, a deposit amount, and a change amount. If the same commodity is purchased more than once, the number of commodities is also recorded.

After the settlement is completed, the user of the portable terminal 70 can acquire the electronic receipt information 29 from the electronic receipt server 20 by operating an electronic receipt application stored on the portable terminal 70. For example, after the settlement is completed, the electronic receipt information 29 is transmitted from the electronic receipt server 20 to a pre-registered e-mail address for the user of the portable terminal 70.

The user may display the e-mailed (or otherwise acquired) electronic receipt information 29 on the display device 80 of his or her portable terminal 70 and check the contents.

The electronic receipt information 29 can be associated with the additional information 30 as provided or instructed by the user. The example of FIG. 8 illustrates that image information and text information have been associated with the electronic receipt information 29 as additional information 30.

The fact that the image information is associated with the electronic receipt information 29 is expressed by adding an image icon Ii to the electronic receipt information 29. The fact that the text information is correlated with the electronic receipt information 29 is expressed by adding a text icon It to the electronic receipt information 29.

The user can display the contents of the particular additional information 30 by pressing the image icon Ii or the text icon It.

The additional information 30 can be associated with the electronic receipt information 29 as a whole, or can be particularly associated with a purchased commodity listed in the electronic receipt information 29.

The example of FIG. 8 illustrates an example in which the additional information 30 is associated with the electronic receipt information 29 as a whole. The example of FIG. 9 illustrates an example in which the additional information 30 is associated with a particular purchased item (“Commodity 1”).

In FIG. 9, an underlining element 36 is added below the entry for “Commodity 1”. The underlining element 36 indicates that additional information 30 is associated with a particular commodity (in this case, “Commodity 1”). Then, in the example of FIG. 9, an image icon Ii and a voice icon Iv are displayed next to the entry for “Commodity 1”. The voice icon Iv indicates that sound information (e.g., a voice memo) is associated with “Commodity 1”.

In this way, by associating the additional information 30 with electronic receipt information 29, the user of the portable terminal 70 can, for example, store a photograph of a purchased product, a comment recorded at the time of purchase, or the like in conjunction with the electronic receipt information 29. Therefore, the electronic receipt information 29 can be used for memorializing information the user considers relevant or potentially useful with regard to purchases or the like.

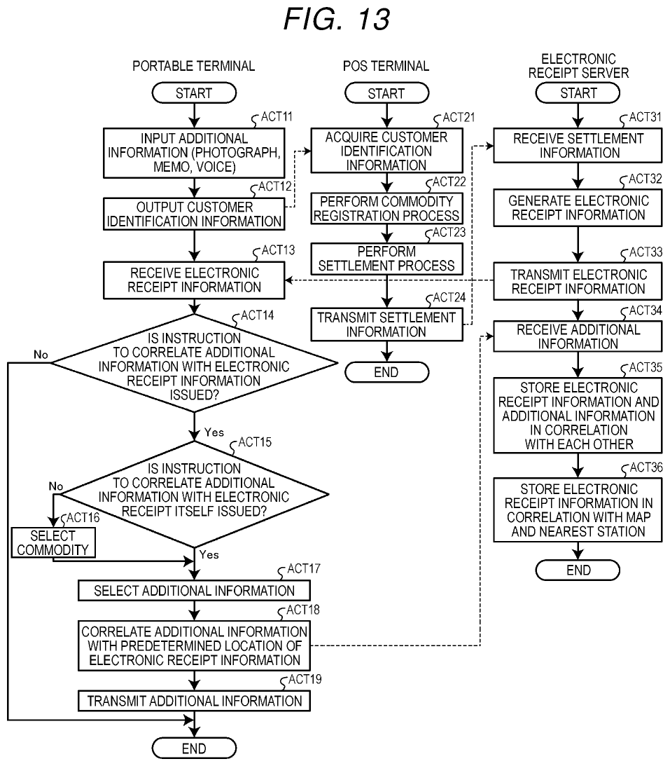

A method of associating the additional information 30 with the electronic receipt information 29 itself or a specific commodity reflected in the electronic receipt information 29 will be described below (see FIG. 13).

Since the purchase date information db is attached to the electronic receipt information 29, the user of the portable terminal 70 can search the past electronic receipt information 29 based on the date and time.

Correlation Between Electronic Receipt Information with Map

The correlation between the electronic receipt information 29 and the map will be described with reference to FIG. 10. FIG. 10 is a diagram illustrating an example in which electronic receipts are correlated with a map and displayed superimposed on the map.

The electronic receipt mapping processing unit 99 of the electronic receipt server 20 associates the generated electronic receipt information 29 with a location of a store 62 on the map 27 at which the settlement process related to the electronic receipt information 29 was performed. The user of the portable terminal 70 can later download the map 27 from the electronic receipt server 20 to select and display the available electronic receipt information 29 from the map 27.

Among the stores on the map 27, an identification icon 37 is displayed on the stores with which electronic receipt information 29 is associated. An electronic receipt icon 38 is also displayed in the vicinity of the identification icon 37. By displaying the identification icon 37, a store with which the electronic receipt icon 38 is associated can be easily understood, even if the stores are densely located on the map 27.

A plurality of electronic receipt icons 38 may be displayed in an overlapping (stacked) manner to indicate that shopping has been conducted at the same store multiple times. Correlation between electronic receipt information with railway route map.

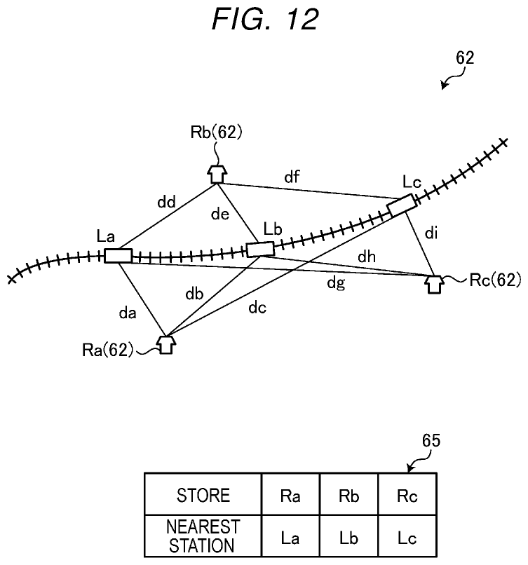

A method of correlating the electronic receipt information 29 with the railway route map will be described with reference to FIGS. 11 and 12. FIG. 11 is a diagram illustrating an example in which an electronic receipt is associated with the nearest railway station and superimposed on the railway route map. FIG. 12 is a diagram illustrating the contents of a process of correlating an electronic receipt with the nearest railway station.

The electronic receipt server 20 associates the electronic receipt information 29 with the station nearest to the store 62 at which settlement related to the electronic receipt information 29 was performed, and displays the electronic receipt information 29 superimposed on the railway route map 28. The user of the portable terminal 70 can download the railway route map 28 from the electronic receipt server 20 to select and then display the electronic receipt information 29 from the railway route map 28.

As illustrated in FIG. 11, the railway route map 28 presents map information in which station names belonging to a specific railway line are listed. However, the railway route map 28 is a map primarily illustrating connection information between different stations along a railway line, and thus differs from a normal map 27 in that the concept of distance (scale) and absolute position may be missing. However, each station name displayed on the railway route map 28 can be correlated with a corresponding station displayed on the map 27. Therefore, the electronic receipt server 20 can associate the electronic receipt information 29 correlated with positions on the map 27 to the nearest station on the map 27, and then associate the electronic receipt information 29 by station name for display on the railway route map 28.

In the example illustrated in FIG. 11, the electronic receipt icons 38 indicating that the electronic receipt information 29 is associated with D station, F station, and K station are superimposed on the railway route map 28. A user displaying the railway route map 28 on the portable terminal 70 can select and then display the electronic receipt information 29 by selecting an electronic receipt icon 38.

When associating the electronic receipt information 29 that is stored in relationship with particular stores 62 with a nearest station, as illustrated in FIG. 12, the railway route map mapping processing unit 100 (see FIG. 5) of the electronic receipt server 20 determines the position of each relevant store 62 and the distance to nearby stations. Then, each store 62 is considered to be associated with the station that is closest thereto (least distance from store 62 to the station).

In FIG. 12, the railway route map mapping processing unit 100 of the electronic receipt server 20 compares the distance between a store Ra (62) and nearby stations. Specifically, a distance da between the store Ra (62) and a station La, a distance db between the store Ra (62) and a station Lb, and a distance dc between the store Ra (62) and a station Lc are calculated and compared. As a result, the station La at the shortest distance is set as the nearest station to the store Ra (62).

Similarly, the railway route map mapping processing unit 100 of the electronic receipt server 20 compares a distance dd between a store Rb (62) and the station La, a distance de between the store Rb (62) and the station Lb, and a distance df between the store Rb (62) and the station Lc. As a result, the station Lb with the shortest distance is set as the nearest station to the store Rb (62). Likewise, the railway route map mapping processing unit 100 of the electronic receipt server 20 compares a distance dg between a store Rc (62) and the station La, a distance dh between the store Rc (62) and the station Lb, and a distance di between the store Rc (62) and the station Lc. As a result, the station Lc with the shortest distance is set as the nearest station to the store Rc (62).

In this way, the railway route map mapping processing unit 100 of the electronic receipt server 20 generates nearest station data 65 as illustrated in FIG. 12.

Since position information of the store 62 (for example, latitude and longitude) is generally known in advance, as long as the railway route map 28 provides corresponding position information of each station displayed on the railway route map 28, the electronic receipt server 20 may directly associate the electronic receipt information 29 correlated by stores 62 with stations on the railway route map 28 without first going through processing associated with the map 27.

### Flow of Additional Information Registration Process Performed by Electronic Receipt System

A flow of an additional information registration process performed by the electronic receipt system 10 will be described with reference to FIG. 13. FIG. 13 is a flowchart illustrating an example of the additional information registration process performed by the electronic receipt system 10 according to the embodiment.

### Flow of Process Performed by Portable Terminal

First, a flow of a process performed by the portable terminal 70 will be described. For example, when eating at a restaurant or shopping at a store, the user of the portable terminal 70 designates or generates an image, text information, or sound information as additional information by operating the camera control unit 120, the text information input unit 121, or the sound input unit 122 (ACT 11). This additional information 30 is temporarily stored in the storage unit 75 or the like of the portable terminal 70.

After eating or shopping is completed, the customer identification information output unit 123 receives an instruction from the user and outputs the customer identification information 76 for the electronic receipt system 10 so the POS terminal 40 can acquire the customer identification information 76 (ACT 12). In ACT S12, the portable terminal 70 may output the customer identification information 76 to the POS terminal 40 via wireless communication. In some examples, the portable terminal 70 may display coded information on the display device 80 and the scanner 52 of the POS terminal 40 can read the coded information to obtain the customer identification information 76.

After a settlement process at the POS terminal 40 is completed, the electronic receipt information receiving unit 125 receives the electronic receipt information 29 indicating a settlement result (ACT 13). The user of the portable terminal 70 may operate an electronic receipt application and receive the electronic receipt information 29 by himself or herself.

The additional information correlation instruction unit 124 determines whether or not an instruction to correlate additional information 30 with the electronic receipt information 29 was issued from the portable terminal 70 via the operation device 81 (ACT 14). If the instruction to correlate additional information with the electronic receipt information 29 is issued (Yes in ACT 14), the process proceeds to ACT 15. On the other hand, if there is no instruction to correlate additional information 30 with the electronic receipt information 29 (No in ACT 14), the portable terminal 70 ends the process of FIG. 13. Whether or not the user's instruction has been issued is determined by whether or not the operation information acquisition unit 128 acquires predetermined operation information.

If it is determined in ACT 14 that the instruction to correlate the additional information 30 with the electronic receipt information 29 was issued, the additional information correlation instruction unit 124 next determines whether or not an instruction to correlate the additional information 30 with the electronic receipt itself was issued from the portable terminal 70 (ACT 15). If the instruction to correlate the additional information 30 with the electronic receipt itself was issued (Yes in ACT 15), the process proceeds to ACT 17. On the other hand, if the instruction to correlate the additional information 30 with the electronic receipt itself was not issued (No in ACT 15), the process proceeds to ACT 16.

If it is determined in ACT 15 that the instruction to correlate the additional information 30 with the electronic receipt itself was issued, the additional information correlation instruction unit 124 requests the user of the portable terminal 70 to select the particular additional information 30 to be associated with the electronic receipt information 29 from the additional information 30 already stored (ACT 17). After that, the process proceeds to ACT 18. The additional information correlation instruction unit 124 may select the additional information 30 associated with the electronic receipt information 29 from the additional information 30 already stored, or may receive the additional information 30 at the time of ACT 17. If the additional information 30 is to be received at the time of ACT 17, the additional information correlation instruction unit 124 may display a text input screen, or may start a camera or a sound recording (or voice memo) application.

On the other hand, if it is not determined in ACT 15 that the instruction to correlate the additional information 30 with the electronic receipt itself is issued, the additional information correlation instruction unit 124 requests the user of the portable terminal 70 to select a commodity (purchased item) with which the additional information 30 is to be associated from the individual commodities recorded in the electronic receipt information 29 (ACT 16). After that, the process proceeds to ACT 17 described above.

Subsequent to ACT 17, the additional information correlation instruction unit 124 correlates the selected additional information 30 with a predetermined location for the electronic receipt information 29 (or a particular item recorded in the electronic receipt information) (ACT 18).

The additional information correlation instruction unit 124 causes the communication control unit 129 to transmit the additional information 30 that has been associated with the electronic receipt information 29, or alternatively identification information for specifying the additional information 30, to the electronic receipt server 20 (ACT 19). After that, the portable terminal 70 ends the process of FIG. 13.

The display control unit 127 generates and then displays screen information on the display device 80 as necessary in each of the actions described above. The operation information acquisition unit 128 acquires operation information of the user as necessary in each of the actions described above.

### Flow of Process Performed by POS Terminal

The customer identification information acquisition unit 110 acquires the customer identification information 76 of the user from the portable terminal 70 (ACT 21).

The accounting processing unit 112 performs the commodity registration process based on code information which includes the commodity information of the commodity purchased by the customer and is read by the scanner 52 by the commodity information acquisition unit 111 (ACT 22). In the case of an eating house such as a restaurant, the commodity information acquisition unit 111 causes the scanner 52 to read the code information printed on a slip brought by the customer.

After all the commodity registrations are completed, the settlement processing unit 113 performs a settlement process (ACT 23).

The settlement information transmitting unit 114 transmits settlement information to the electronic receipt server 20 (ACT 24). In this case, the customer identification information 76 of the user acquired in ACT 21 is also transmitted. After that, the POS terminal 40 ends the process of FIG. 13.

The display control unit 117 generates and displays screen information to be displayed on the display device 50 as necessary in each of the actions described above. The operation information acquisition unit 118 acquires operation information of the operator of the POS terminal 40 as necessary in each of the actions described above.

### Flow of Process Performed by Electronic Receipt Server

The settlement information receiving unit 90 receives settlement information from the POS terminal 40 via the store server 60 (ACT 31). The settlement information also includes the customer identification information 76 of the user.

The electronic receipt information generation unit 91 generates the electronic receipt information 29 based on the settlement information (ACT 32).

The electronic receipt information transmitting unit 96 transmits the generated electronic receipt information 29 to the POS terminal 40 and an e-mail address registered in the customer identification information 76 included in the settlement information (ACT 33).

The additional information acquisition unit 92 receives the additional information 30 from the portable terminal 70 (ACT 34). The additional information 30 may be identification information that refers to the additional information 30 stored in the portable terminal 70.

The additional information correlation unit 94 associates the electronic receipt information 29 with the additional information 30. Then, the electronic receipt information storage unit 95 stores the electronic receipt information 29 associated with the additional information 30 (ACT 35).

The electronic receipt mapping processing unit 99 stores the electronic receipt information 29 in correlation with the map 27. The electronic receipt mapping processing unit 99 stores the electronic receipt information 29 in correlation with the nearest station to the store 62 where the settlement was performed (ACT 36). After that, the electronic receipt server 20 ends the process illustrated in FIG. 13.

Instead of ACT 32, the POS terminal 40 may generate electronic receipt information based on the settlement information after the settlement process in ACT 23. Instead of ACT 24, the electronic receipt information generated by the POS terminal 40 may be transmitted to the electronic receipt server 20.

### Flow of Additional Information Displaying Process Performed by Electronic Receipt System

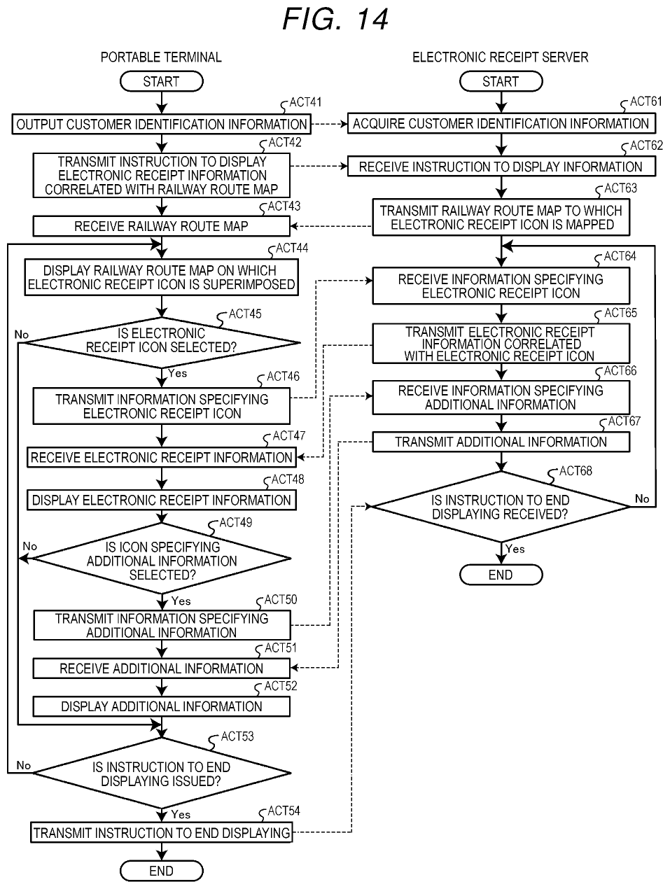

A flow of an additional information displaying process performed by the electronic receipt system 10 will be described with reference to FIG. 14. FIG. 14 is a flowchart illustrating an example of the additional information displaying process performed by the electronic receipt system according to the embodiment. In particular, FIG. 14 illustrates a process for the user of the portable terminal 70 to display the electronic receipt information 29 correlated with the railway route map 28.

### Flow of Process Performed by Portable Terminal

When displaying the electronic receipt information 29, first, the customer identification information output unit 123 transmits the customer identification information 76 to the electronic receipt server 20 (ACT 41).

Subsequently, the electronic receipt information displaying processing unit 126 transmits an instruction to display the electronic receipt information 29 correlated with the railway route map 28 to the electronic receipt server 20 (ACT 42). In this case, a specific railway line name is instructed from the portable terminal 70 to the electronic receipt server 20.

The electronic receipt information displaying processing unit 126 receives the railway route map 28 on which the electronic receipt icon 38 is mapped from the electronic receipt server 20 (ACT 43).

The electronic receipt information displaying processing unit 126 causes the display control unit 127 to display the railway route map 28 on which the electronic receipt icon 38 is superimposed on the display device 80 (ACT 44).

The electronic receipt information displaying processing unit 126 determines whether or not the electronic receipt icon 38 is selected (ACT 45). If it is determined that the electronic receipt icon 38 has been selected (Yes in ACT 45), the process proceeds to ACT 46. On the other hand, if the electronic receipt icon 38 has not been selected (No in ACT 45), the process proceeds to ACT 53.

If it is determined in ACT 45 that the electronic receipt icon 38 has been selected, the electronic receipt information displaying processing unit 126 transmits information specifying the electronic receipt icon 38 to the electronic receipt server 20 (ACT 46). The information specifying the electronic receipt icon 38 is, for example, the identification information given to each electronic receipt icon 38 by the electronic receipt server 20.

The electronic receipt information receiving unit 125 receives the electronic receipt information 29 associated with the electronic receipt icon 38 from the electronic receipt server 20 (ACT 47).

The electronic receipt information displaying processing unit 126 causes the display control unit 127 to display the received electronic receipt information 29 on the display device 80 (ACT 48).

The electronic receipt information displaying processing unit 126 determines whether or not an icon specifying the additional information 30 has been selected based on the operation information acquired by the operation information acquisition unit 128 (ACT 49). If it is determined that the icon specifying the additional information 30 has been selected (Yes in ACT 49), the process proceeds to ACT 50. On the other hand, if the icon specifying the additional information 30 has not been selected (No in ACT 49), the process proceeds to ACT 53.

If it is determined in ACT 49 that the icon specifying the additional information 30 has been selected, the electronic receipt information displaying processing unit 126 transmits information specifying the additional information 30 to the electronic receipt server 20 (ACT 50). The information specifying the additional information 30 is, for example, identification information specifying the additional information 30.

The electronic receipt information displaying processing unit 126 receives the additional information 30 from the electronic receipt server 20 (ACT 51).

The electronic receipt information displaying processing unit 126 causes the display control unit 127 to display the received additional information 30 on the display device 80 (ACT 52).

The electronic receipt information displaying processing unit 126 determines whether or not an instruction to end displaying has been issued based on the operation information acquired by the operation information acquisition unit 128 (ACT 53). If it is determined that the instruction to end displaying has been issued (Yes in ACT 53), the process proceeds to ACT 54. On the other hand, if the instruction to end displaying has not been issued (No in ACT 53), the process returns to ACT 44.

If it is determined in ACT 53 that the instruction to end displaying has been issued, the electronic receipt information displaying processing unit 126 instructs the electronic receipt server 20 to end displaying (ACT 54). After that, the portable terminal 70 ends the process of FIG. 14.

### Flow of Process Performed by Electronic Receipt Server

The customer identification information acquisition unit 97 receives the customer identification information 76 from the portable terminal 70 (ACT 61).

The displaying instruction receiving unit 98 receives an instruction to display the electronic receipt information 29 correlated with the railway route map 28 from the portable terminal 70 (ACT 62).

The electronic receipt mapping processing unit 99 transmits the railway route map 28 to which the electronic receipt icon 38 is mapped to the portable terminal 70 (ACT 63).

The electronic receipt mapping processing unit 99 receives information specifying the electronic receipt icon 38 from the portable terminal 70 (ACT 64).

The electronic receipt information transmitting unit 96 transmits the electronic receipt information 29 correlated with the electronic receipt icon 38 to the portable terminal 70 (ACT 65).

The additional information display processing unit 102 receives information specifying the additional information 30 from the portable terminal 70 (ACT 66).

The additional information display processing unit 102 transmits the additional information 30 to the portable terminal 70 (ACT 67).

The displaying instruction receiving unit 98 determines whether or not the instruction to end displaying has been received from the portable terminal 70 (ACT 68). If it is determined that the instruction to end displaying has been received (Yes in ACT 68), the electronic receipt server 20 ends the process of FIG. 14. On the other hand, if the instruction to end displaying has not been received (No in ACT 68), the process returns to ACT 64.

Although FIG. 14 particularly illustrates the flow of the process of displaying the electronic receipt information 29 correlated with the railway route map 28, the process of displaying the electronic receipt information 29 correlated with the map 27 is also performed with substantially the same flow. Thus, process of simply displaying the electronic receipt information 29 on map 27 or otherwise can also be performed with the same overall process flow as FIG. 14. The method for displaying the electronic receipt information 29 can be selected from a main menu of an electronic receipt displaying application installed on the portable terminal 70 or the like.

In the description of the above example embodiments, it is assumed that the electronic receipt server 20 generates the electronic receipt information 29, correlates the additional information 30 with the generated electronic receipt information 29, and maps the electronic receipt information 29 to the map 27 and/or the railway route map 28. However, such processes may be shared or distributed among a plurality of servers or devices.

### Effect of Embodiment

An electronic receipt server 20 (of an embodiment includes the electronic receipt information generation unit 91 that generates the electronic receipt information 29 including commodity information of a sold commodity, the additional information acquisition unit 92 that acquires the additional information 30, which includes the store position information, and the electronic receipt information storage unit 95 that stores the electronic receipt information 29 and the additional information 30 in association with each other. Therefore, the additional information 30 can be stored with the electronic receipt information 29. With this configuration, the user can more efficiently trace past records using electronic receipt information 29.

The electronic receipt server 20 of an embodiment further includes the additional information correlation destination selection unit 93 that permits the user of the portable terminal 70 to select (designate) whether to associate additional information 30 with the electronic receipt information 29 itself or to correlate the additional information 30 with an individual item included in the electronic receipt information 29. Therefore, the additional information 30 can be associated according to the intention or preference of the user.

The electronic receipt server 20 of an embodiment includes the icon display processing unit 101 that superimposes and displays the electronic receipt icon(s) 38 on a position correlated with the position information of the map 27 on the display device 80. The additional information display processing unit 102 causes the display device 80 of the portable terminal 70 to display the additional information associated with the electronic receipt information 29 corresponding to the electronic receipt icon 38 when selected by the user. Therefore, the user can freely display the electronic receipt information 29 and the corresponding additional information 30 on his or her portable terminal 70.

In the electronic receipt server 20 of an embodiment, the electronic receipt information storage unit 95 causes the additional information 30 to be stored in association with electronic receipt information 29 on the condition that the settlement process related to the electronic receipt information 29 is completed. In such a manner, an erroneous attempt to correlate the additional information 30 with electronic receipt information 29 without successful generation of the electronic receipt information 29 can be prevented.

In the electronic receipt server 20 (an information processing apparatus) of an embodiment, the additional information 30 can be image information, text information, or sound information. But, in general, any information type without limitation according to the intention or preference of the user can be associated with the electronic receipt information 29.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus for an electronic receipt system, the apparatus comprising:
a communication interface configured to connect to a store server and a portable terminal;
a control unit configured to:
generate electronic receipt information based on commodity transaction information received from the store server via the communication interface;
acquire position information corresponding to the commodity transaction information; and
store the electronic receipt information and the position information in association with each other.

2. The information processing apparatus according to claim 1, wherein the control unit is further configured:
send the electronic receipt information and the associated the position information to the portable terminal via the communication interface.

3. The information processing apparatus according to claim 1, wherein the control unit is further configured receive an instruction, via the communication interface, from the portable terminal to select whether to associate additional information with the electronic receipt information or an individual commodity included in the electronic receipt information.

4. The information processing apparatus according to claim 3, wherein the additional information is a photograph, a voice memo, or a text memo.

5. The information processing apparatus according to claim 3, wherein the control unit is further configured to provide a map with an icon corresponding to the electronic receipt information at a position on the map corresponding to the position information associated with the electronic receipt information.

6. The information processing apparatus according to claim 5, wherein the icon indicates whether the additional information is associated with the electronic receipt information.

7. The information processing apparatus according to claim 5, wherein the map is a railway map and the position on the map is a railway station nearest to a store position matching the position information associated with the electronic receipt information.

8. The information processing apparatus according to claim 1, wherein the control unit is further configured to associate additional information with the electronic receipt information or an individual commodity included in the electronic receipt information.

9. The information processing apparatus according to claim 8, wherein the additional information is a photograph, a voice memo, or a text memo.

10. The information processing apparatus according to claim 1, wherein the control unit is further configured to provide a map with an icon corresponding to the electronic receipt information at a position on the map corresponding to the position information associated with the electronic receipt information.

11. The information processing apparatus according to claim 10, wherein the map is a railway map and the position on the map is a railway station nearest to a store position matching the position information associated with the electronic receipt information.

12. A method for an electronic receipt system, the method comprising:
generating electronic receipt information based on commodity transaction information received from a store server via a communication interface;
acquiring position information corresponding to the commodity transaction information; and
storing the electronic receipt information and the position information in association with each other.

13. The method according to claim 12, further comprising:
sending the electronic receipt information and the associated the position information to a portable terminal via the communication interface.

14. The method according to claim 12, further comprising:
receiving an instruction, via the communication interface, from the portable terminal to select whether to associate additional information with the electronic receipt information or an individual commodity included in the electronic receipt information.

15. The method according to claim 14, wherein the additional information is a photograph, a voice memo, or a text memo.

16. The method according to claim 12, further comprising:
associating additional information with the electronic receipt information or an individual commodity included in the electronic receipt information.

17. The method according to claim 16, wherein the additional information is a photograph, a voice memo, or a text memo.

18. The method according to claim 12, further comprising:
providing a map with an icon corresponding to the electronic receipt information at a position on the map corresponding to the position information associated with the electronic receipt information.

19. The method according to claim 18, wherein the map is a railway map and the position on the map is a railway station nearest to a store position matching the position information associated with the electronic receipt information.

20. The method according to claim 19, further comprising:
determining which of one of a plurality of railway stations on the railway map is the nearest to the store position.
